(19) United States
(12) Patent Application Publication
(10) Pub. No.: US 2007/0064413 A1
(43) Pub. Date: Mar. 22, 2007

(54) Electroluminescent wire light source on a baseball cap

(75) Inventor: Jesse F. Slater, Pacoima, CA (US)

Correspondence Address: William Propp, Esq.;PMB1-245, 8205 Santa Monica Blvd., West Hollywood, CA, 90046, US

(73) Assignee: MiracleBeam Products, Inc.

(21) Appl. No.: 11/228,752

(22) Filed: Sep. 16, 2005

(51) Int. Cl. F21V 21/084

(52) U.S. Cl. 362/106

(57) ABSTRACT

A baseball cap has an electroluminescent wire light source mounted on an exterior surface as an illuminated display pattern. The electroluminescent wire light source has a power supply and control circuit on an interior surface of the baseball cap.

### BACKGROUND OF THE INVENTION

This invention relates generally to a lighting display on a baseball cap and, more particularly, this invention is directed to an electroluminescent wire light source as an illuminated display pattern on a baseball cap.

Caps, in particular baseball caps, and other headwear, are very popular. Their primary purpose is to protect the wearer's eyes and head from sunlight, rain and other weather conditions.

The baseball caps are generally made of fabric, wool, cotton, nylon, polyester, plastic or a woven material. The caps will have a hemispherical crown or dome to cover the upper portion of the head of the wearer. The crown may also be cylindrical with a flat top.

A stiff bill or visor is provided at the lower, front, outside edge of the cap crown. The bill extends over the face of the wearer and serves to help keep the sun or rain out of the eyes of the wearer. The material of the bill is usually harder and more rigid than the soft pliant material of the crown.

Typically, at the back of the crown on the lower edge is a headband with adjustable straps for securing the cap to the head. An opening is provided in the back of the crown above the straps. The straps are generally plastic and overlap each other. The straps are adjustable with respect to each other in the opening to change the size of the cap to accommodate a plurality of different head sizes for the wearers. The lower inside edge of the crown may also have a sweatband to help absorb seat from the wearer's forehead.

Baseball caps can also serve as a fashion statement, by themselves or by incorporating a design. The outside front portion of the crown of the baseball cap can be decorated with a screen-printed or stitch-embroidered design, such as a sports team name, a logo, a trademark, the name of a special event, a cartoon character, etcetera.

It has become fashionable to wear the baseball cap backwards on the head of the wearer with the bill directed rearward over the back of the neck of the wearer. The adjustable straps of the crown are accordingly directed forward covering the forehead and above the face of the wearer.

Traditionally, the bill is bowed downward over the forehead to provide shade and rain protection for the wearer's eyes. It has also become fashionable to wear the baseball cap with the bill flipped up or bowed upward.

Incandescent light bulbs can be used for lighted baseball caps. However, incandescent light sources generate a significant amount of heat. An incandescent light bulb on a baseball cap will generate heat near the face, hair and head of the cap wearer.

Incandescent light sources and their battery power sources are heavy. An incandescent light bulb and a battery on a baseball cap will weigh down on the head of the cap wearer. Small incandescent light sources do not generate significant illumination. Small batteries also do not generate significant illumination for incandescent light sources, are depleted quickly and must be replaced often.

Incandescent light sources are bulky and fragile. They are not shock proof, nor waterproof.

Incandescent light sources tend to have a limited angle of illumination. Incandescent light sources cannot provide a continuous line of light, but only intermittent points at spaced intervals along a line. The incandescent light sources are not small enough and flexible enough to provide an illuminated design on a baseball cap.

The alternative light source for baseball caps is optical fibers. Optical fibers can be bundled together with a light source, which does not generate heat and is lightweight. Unfortunately, optical fibers require an intense, powerful light source. The optical fiber light source, such as a laser or LED, on a baseball cap will generate heat near the face, hair and head of the cap wearer.

Optical fiber light sources and their battery power sources are heavy. An optical fiber light source and a battery on a baseball cap will weigh down on the head of the cap wearer. Small lightweight optical fiber light sources do not generate significant illumination. Small lightweight batteries also do not generate significant illumination for optical fiber light sources, are depleted quickly and must be replaced often.

The battery power sources for an optical fiber light source are also bulky.

Optical fibers tend to only glow along their length with just one end of the optical fiber emitting bright light.

Electroluminescent phosphors (or electroluminophors) luminesce in the presence of an appropriate electrical field. If the electroluminescent phosphors are positioned in a fluctuating electrical field, such as between a pair of conductors connected to an alternating current power source, the phosphors will be excited to luminescence, with the color of the emitted light being dependent essentially on the type of electroluminophor powder utilized in the electroluminescent light source.

An electroluminescent wire will have an electroluminophor dispersed in a dielectric binder, as taught in U.S. Pat. Nos. 5,485,355 and 5,869,930, herein incorporated by reference. An alternating current is applied to the two electrodes within the electroluminescent wire creating an electric field which causes the electroluminescent wire to emit light. Different electroluminophor powders luminesce different colored light. If light of a specific color is desired, then the appropriate electroluminophor powder should be selected for the electroluminescent wire.

It is an object of the present invention to provide a lightweight, non-heat producing, and flexible light source for an illuminated display pattern on a baseball cap.

It is another object of the present invention to provide an electroluminescent wire light source for an illuminated display pattern on a baseball cap.

### SUMMARY OF THE INVENTION

According to the present invention, an electroluminescent wire (EL wire) light source forms an illuminated display pattern on a baseball cap.

The baseball cap will have a hemispherical crown and a stiff bill on the front of the crown.

The electroluminescent wire illumination system for the baseball cap consists of an electroluminescent wire (or EL wire) light source and a power supply and control circuit.

The electroluminescent wire light source has electroluminescent material between a first and second electrode with a translucent sheath enclosing the electrodes and electroluminescent material. The electroluminescent material can emit light of a single color or segments of the material can emit light of different colors. The translucent sheath can color the emitted light or segments of the sheath can color light of different colors.

The power supply and control circuit has a DC power source such as a battery, a DC/AC inverter for converting the direct current from the battery to an alternating current, an on/off switch to turn the electroluminescent wire light source on and off and a control circuit to control the timing and patterns of the light emitted by the electroluminescent wire light source.

The electroluminescent wire light source is mounted on the exterior surface of the baseball cap on the crown or on the bill. The power supply and control circuit is mounted on the interior surface of the baseball cap between the crown and a hat band or on the crown. Wires connect electroluminescent wire light source and the power supply and control circuit.

Multiple electroluminescent wire light sources on the baseball cap can form a time sequenced illuminated pattern.

Other aspects of the invention will become apparent from the following more detailed description, taken in conjunction with the accompanying drawings.

### BRIEF DESCRIPTION OF THE DRAWINGS

The preferred embodiments of this invention will be described in detail, with reference to the following figures wherein:

FIG. 1 is a top view of the electroluminescent wire light source on the edge of the bill of a baseball cap of the present invention.

FIG. 2 is a bottom view of the electroluminescent wire light source on the edge of the bill and the power supply and control circuit inside the baseball cap of FIG. 1.

FIG. 3 is a side cut-away view of the electroluminescent wire light source and the power supply and control circuit of FIGS. 1 and 2.

FIG. 4 is a bottom perspective view of the electroluminescent wire light source on the edge of the bill and crown and the power supply and control circuit inside the baseball cap of the present invention.

FIG. 5 is a side view of the electroluminescent wire light source on the seams of the crown of the baseball cap of the present invention.

FIG. 6 is a side view of the control circuit for multiple electroluminescent wire light sources of the present invention.

FIG. 7 is a side view of the electroluminescent wire light source on the button of the crown of the baseball cap of the present invention.

FIG. 8 is a front view of the electroluminescent wire light source forming a star illuminated display pattern on the front panels of the baseball cap of the present invention.

FIG. 9 is a front view of the electroluminescent wire light source forming a star illuminated display pattern on the upper bill of the baseball cap of the present invention.

FIG. 10 is front view of the electroluminescent wire light source forming a star illuminated display pattern on the lower bill of the baseball cap of the present invention.

FIG. 11 is back view of the electroluminescent wire light source forming a star illuminated display pattern on the back panels of the baseball cap of the present invention.

FIG. 12 is a front view of multiple star patterns of electroluminescent wire light sources in a time sequenced illuminated pattern on the front panels of the baseball cap of the present invention.

FIG. 13 is a front view of a single star pattern formed of multiple segments of electroluminescent wire light sources in a time sequenced illuminated pattern on the front panels of the baseball cap of the present invention.

### DETAILED DESCRIPTION OF PREFERRED EMBODIMENTS

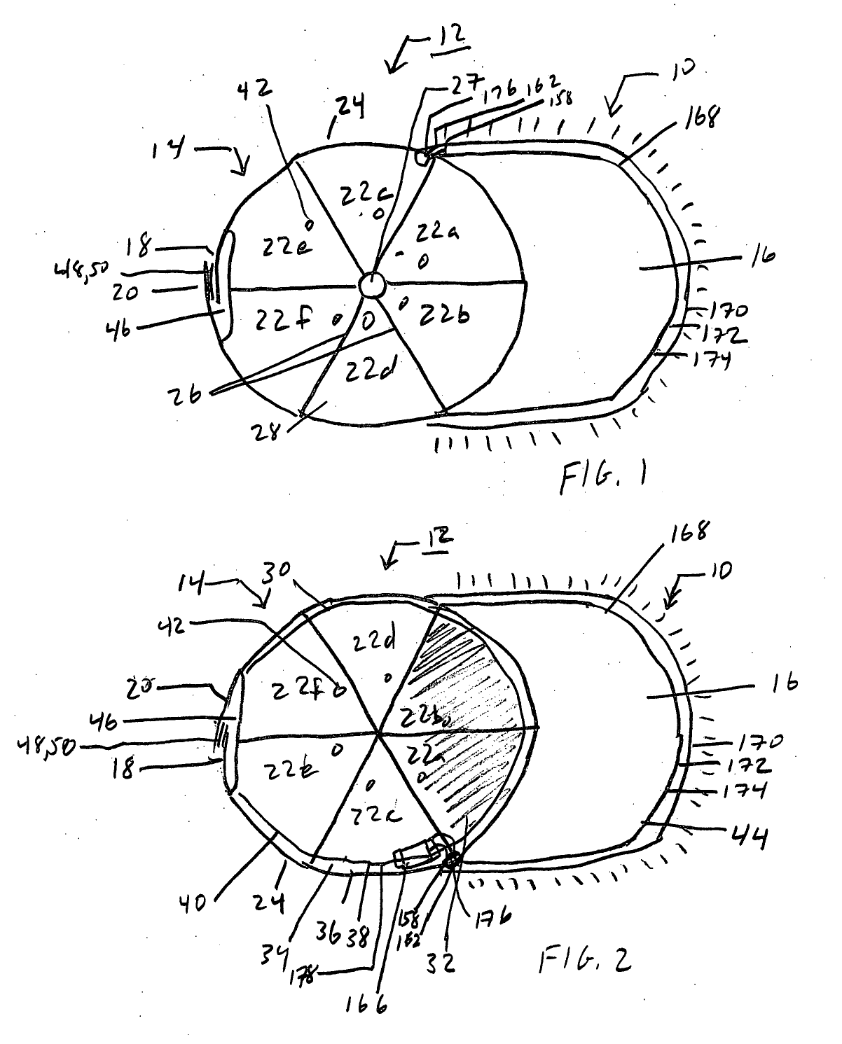

Reference is now made to FIGS. 1 and 2 illustrating an electroluminescent wire (EL wire) light source 10 as an illuminated display pattern for a baseball cap 12 of the present invention.

The baseball cap will have a hemispherical crown 14, a stiff bill 16 on the front of the crown and adjustable straps 18, 20 at the back of the crown. The electroluminescent wire is used as an illuminated edge or trim to the baseball cap, or as an illuminated design on the baseball cap or an illuminated marking on the baseball cap.

The baseball cap 12 will have a hemispherical crown 14 or dome to cover the upper portion of the head of the wearer. Typically, the crown is constructed of six, generally triangular, fabric panels 22. Two of the sides of the triangular panels are of equal length. The equal length sides of adjacent panels are sewn together to form the hemispherical shape of the crown. The fabric panels converge at the peak of the crown where a fabric-covered button is sewn.

Generally, the six panels are arranged so that adjacent first panel 22a and second panel 22b are at the front of the crown 14 of the baseball cap 12. A third side panel 22c is adjacent to the first front panel 22a and a fourth side panel 22d is adjacent to the second front panel 22b. The adjacent fifth panel 22e and sixth panel 22f are at the back of the crown of the baseball cap. The fifth back panel 22e is adjacent to the third side panel 22c and the sixth back panel 22f is adjacent to the fourth side panel 33d.

The remaining non-equal length side of the six triangular panels will form the lower circumferential edge 24 of the crown 14. The lower edge of the crown may be stitched or embroidered to form a generally smooth fabric surface.

The stitching between adjacent panels forms seams 26 extending generally parallel to each other from the lower circumferential edge 24 of the crown to the button 27 at the peak of the crown.

Sewing is the traditional method for attaching the adjacent panels 22 together but adhesive and bonding are also possible securing means.

The crown 14 of the baseball cap forms an exterior surface 28 and an interior surface 30.

A reinforcing layer 32 of fabric or a stiffer material is sewn to the inside surface of the front first and second panels 22a and 22b to provide a rigid front to the baseball cap crown.

A hat band 34 is sewn or otherwise attached to the lower circumferential portion 24 of the interior surface 30 of the crown 14 to provide a stiff lower edge to the crown and to help the wearer put on and remove the baseball cap from the wearer's head. The hat band 34 is closed on the lower edge 36 at the lower circumferential edge of the crown but may be open at the upper edge 38. The hat band may include a sweatband 40 or a strip of absorbent material to absorb perspiration from the wearer's head. The sweatband also provides a soft comfortable fit to the head within the crown of the baseball cap.

The baseball cap has air holes 42 located around the crown 14 to allow air to circulate under the cap and allow heat to escape from beneath the cap. The air holes 42 are typically eyelets.

The hemispherical shape of the crown is merely an illustrative example. The crown of the baseball cap can be square, triangular, cylindrical or other unique shapes. The crown may be formed of unitary construction with no separate panels or seams. The crown may be formed of plastic or polymer materials.

A stiff bill 16 or visor extends out from the front of the outside surface of baseball cap. The bill 16 is typically sewn to the lower edge 24 of the first and second front panels 22a and 22b of the crown 14. The bill includes a substantially arcuate brim 44, which extends outward from the crown 14, perpendicular to the first and second front panels 22a and 22b.

The bill 16 includes an inner rigid layer (not shown in the Figure) typically of cardboard, plastic or stiff fabric, covered with a top and bottom layer of the same fabric material as the crown. The covering material of the bill may be different from the material of the crown, however.

The top layer of covering material, the inner rigid layer, and the bottom layer of the covering material are typically sewn together to form the bill.

The bill extends over the face of the wearer to shield the eyes of the wearer from the sun, rain and other weather conditions.

Alternately, the bill can be a top and bottom layer of a more rigid fabric material than the crown, or a single layer of a more rigid fabric material than the crown.

The bill is typically flat and sloped down from the crown or, as shown in the Figure, the bill 16 is curved, with a convex surface from above and a concave surface from below.

While the bill 16 of the baseball cap is generally rigid or shape retentive, the crown 14 is more flexible for a better fit on the wearer's head.

An opening 46 is provided at the lower edge 24 of the back of the crown in the fifth back panel 22e and the sixth back panel 22f. The opening may be semi-circular, semi-elliptical or some other selected shape.

A first adjustable strap 18 will extend from the fifth back panel 22e and a second adjustable strap 20 will extend from the sixth back panel 22f. The straps are generally plastic or nylon and are sewn or otherwise attached to their respective back panel of the crown. The two adjustable straps 18 and 22 will overlap in the opening 46. Adjusting the overlap of the straps adjusts the size of the baseball cap to fit the head of the wearer.

The straps can be adjustable by the use of a buckle, clasp, button, snaps or other fastener, a series of projections on one strap and a corresponding series of holes on the other strap, or, as shown in the Figure, the two straps 18 and 22 can have corresponding and opposing Velcro hook and pile strips 48 and 50.

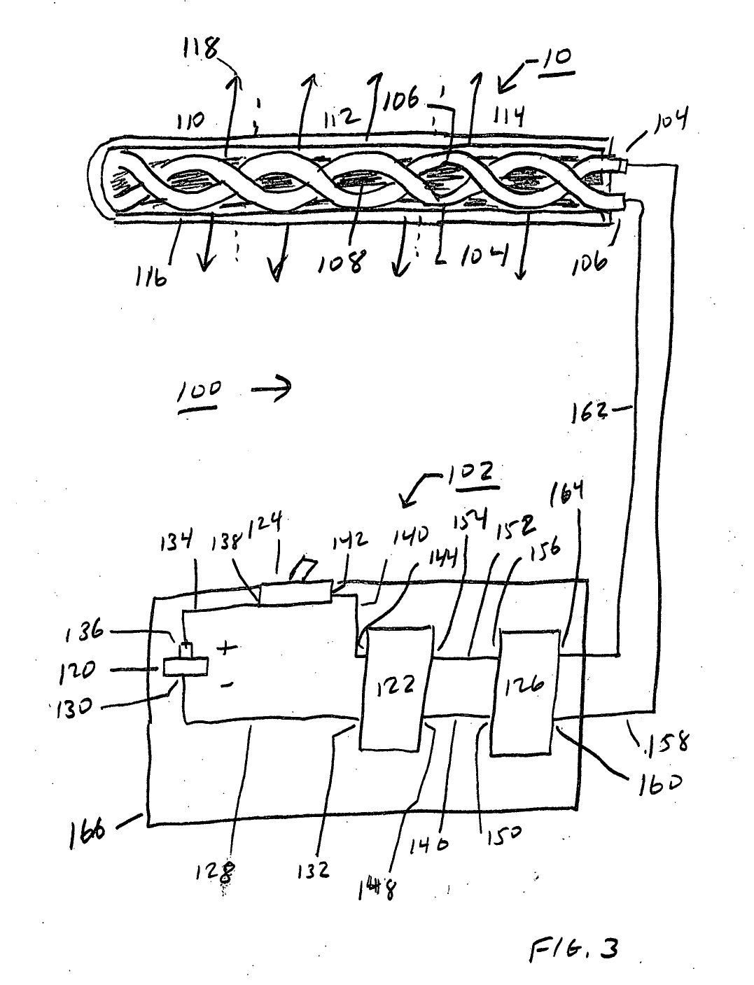

The electroluminescent wire illumination system 100 for the baseball cap 12 of FIGS. 1 and 2 consists of an electroluminescent wire (or EL wire) light source 10 and a power supply and control circuit 102, as shown in FIG. 3. The light source and power supply and control circuit are shown exaggerated in relative size in the Figure for ease of understanding.

The electroluminescent wire light source 10 in FIG. 3 has a first electrode 104 and a second electrode 106 in a double helix configuration. The first and second electrodes are typically long length, small diameter, cylindrical wires formed of copper or other electrically conductive metals. The first and second electrodes will be twisted around each other with a fixed pitch down the length of the generally cylindrical electroluminescent wire light source.

The helical hollows formed between the helical electrodes are filled with an electroluminescent material 108, which will typically comprise an electroluminophor powders dispersed in epoxy resin or other dielectric binding material.

In the alternative, the electroluminescent wire light source can have a central internal core electrode with a layer of an electroluminescent phosphor surrounding the core electrode and an external electrode spirally wound about the phosphor layer.

The color of the light which will be emitted by the electroluminescent wire light source is dependent on the type of electroluminophor powders selected. As discussed in the aforementioned U.S. Pat. No. 5,485,335, different electroluminophor powders may typically principally emit red, green, yellow, white, or blue light when excited by an appropriate electrical source.

The same electroluminophor powder can be distributed along the length of the electroluminescent wire so that the electroluminescent wire light source will emit monochrome light of the same color.

Alternately, the electroluminescent wire can be divided into a plurality of continuous and contiguous segments 110, 112, and 114. A different electroluminophor powder can be distributed in adjacent segments of the electroluminescent wire along the length of each segment so that segment of electroluminescent wire light source will emit light of a different color. The electroluminescent wire light source will emit polychrome light of at least two different colors. If each segment in a plurality of segments has a different electroluminophor powder, then the electroluminescent wire light source will emit polychrome light of a plurality of colors. A pattern of colors from the electroluminescent wire light source can be formed by patterning the sections of different electroluminophor powders in the resin.

A translucent or transparent sheath 116 encloses the first and second electrodes and the electroluminescent material forming the cylindrical electroluminescent wire light source. The sheath is typically a plastic or a polymer, such as a thin flexible polyvinylchloride (PVC) or polytetrafluoroethylene (PTFE).

The powder particles in the resin in the electroluminescent material, when subjected to an alternating electric field, will emit light 118. The light exits through the clearances between the helical twin electrodes and through the translucent sheath.

The sheath is clear and transparent to the colors of the light emitted by the electroluminescent material inside.

The sheath may be colored to color the light emitted by the electroluminescent material inside. Even with an electroluminescent wire light source emitting light of the same color along its length, a pattern of colors from the light source can be formed by patterning sections of the translucent sheath with different colors.

The sheath may be colored with a first color, the electroluminescent wire light source can emit light of a second color, and the combination of the second color being transmitted through the first color will yield a visible light of a third color.

The translucent sheath is durable, scruff-resistant, flexible and protects the electroluminescent material and electrodes inside from rain, sun and other weather conditions.

When the electroluminescent wire is powered with a current of electricity, the electroluminescent wire emits light along its length. The color of the light emitted depends upon the internal composition of the electroluminescent wire and the color of the translucent sheath. The most common types of electroluminescent wire that are commercially available emit green, blue, red, white or yellow light. The sheath can be any color to color the emitted light from the electroluminescent wire.

The electroluminescent wire light source 10 provides a continuous line of illumination along its length. The electroluminescent wire light source is compact, flexible and easily shapeable into different physical patterns. The illumination display pattern of the electroluminescent wire light source may include a plurality of lights of different colors to enhance its attractiveness and interest.

The power supply and control circuit 102 in FIG. 3 for the electroluminescent wire light source consists of a DC power source 120, a DC/AC inverter 122, an on/off switch 124 and a control circuit 126.

The DC power source 120 is a battery, typically one or more penlight, watch, or coin batteries. The battery can be replaceable or rechargeable as the power supply for the electroluminescent wire light source.

The DC power source 120 is electrically connected to the on/off switch 124 and the DC/AC inverter 122. All wires in the power supply and control circuit are electrically conductive. A first wire 128 connects the negative terminal 130 of the battery 120 to the first input terminal 132 of the DC/AC inverter 122. A second wire 134 connects the positive terminal 136 of the battery 120 to the first terminal 138 of the switch 124. A third wire 140 connects the second terminal 142 of the switch 124 to the second input terminal 144 of the DC/AC inverter 122.

The DC/AC inverter 122 is electrically connected to the control circuit 126. A fourth wire 146 connects the third output terminal 148 of the DC/AC inverter 122 to the first input terminal 150 of the control circuit 126. A fifth wire 152 connects the fourth output terminal 154 of the DC/AC inverter 122 to the second input terminal 156 of the control circuit 126.

The control circuit 126 is electrically connected to the electroluminescent wire light source 10. A sixth wire 158 connects the third output terminal 160 of the control circuit 126 to the first electrode 104 of the electroluminescent wire light source 10. A seventh wire 162 connects the fourth output terminal 164 of the control circuit to the second electrode 106 of the electroluminescent wire light source 10. The sixth wire 158 of the power supply and control circuit can be the first electrode 104 of the electroluminescent wire light source and the seventh wire 162 of the power supply and control circuit can be the second electrode 106 of the electroluminescent wire light source.

The on/off switch 124 is typically a sliding switch or a pushbutton switch. The switch is typically manually operated. The switch can alternately by motion sensitive to supply power and the resulting emission of light from the electroluminescent wire light source upon movement of the baseball cap, usually caused by movement of the wearer.

The on/off switch 124 is positioned between the DC power source 120 and the inverter 122. When the switch is closed to on, the electric circuit for the electroluminescent wire light source is completed and the electroluminescent wire light source will emit light.

The DC power source is typically a 1.5 to 9 volt battery or series of batteries to produce 1.5 to 9 volts.

The direct current is sent from the DC power source 120 to the DC/AC inverter 122. The inverter converts the direct current to an alternating current. The DC/AC inverter can also provide a desired frequency for the alternating current. The inverter can also includes a transformer (not shown in this Figure) to increase or decrease the voltage of the alternating current.

The alternating current is sent from the DC/AC inverter 122 to the control circuit 126. The control circuit can maintain a steady emitted light from the electroluminescent wire light source, dim or brighten the emitted light from the electroluminescent wire light source, or interrupt the alternating current to provide a flashing pattern to the emitted light from the electroluminescent wire light source. The flashing pattern can be regular interval flashing, random interval flashing, phased in and phased out flashing, or sequential patterned flashing. The control circuit can provide a timed pattern to the illumination of the emitted light from the electroluminescent wire light source or a random pattern to the illumination of the emitted light from the electroluminescent wire light source.

The alternating current is sent from the control circuit 126 to the electroluminescent wire light source 10 resulting in the electroluminescent wire light source emitting light. When the electroluminescent wire light source is in its luminescent condition and emitting light, the electroluminescent wire light source will provide a continuous light along its length.

The 1.5 to 9 volt DC power source, in conjunction with the DC/AC inverter, can provide the requisite current to cause the electroluminescent wire light source to emit light.

The electroluminescent wire light source can be turned on and off by means of the switch. When the switch is in the open or off position, the electric circuit for the electroluminescent wire light source is not completed, power is not being sent from the power supply to the electroluminescent wire light source, and the electroluminescent wire light source will not emit light.

The power supply and control circuit of the DC power source, the DC/AC inverter, the on/off switch and the control circuit may be assembled into a single unit 166 which is connected by the first electrode and the second electrode to the electroluminescent wire light source. The single unit 166 can be fabricated from a durable, lightweight material such as plastic. The on/off switch 124 should be accessible from the outside of the single unit.

The power supply and control circuit is typically small, thin and lightweight.

Alternately, the control circuit can be part of the on/off switch.

Alternately, a control circuit may not be needed if the power supply simply needs to be turned on and off (by the switch) for the electroluminescent wire light source to emit or not emit light. In that case, the DC/AC inverter would be directly electrically connected to the first and second electrodes of the electroluminescent wire light source.

Alternately, the switch can be positioned between the negative terminal of the power supply and the inverter, or be positioned between the inverter and the control circuit, or be positioned between the control circuit and the electroluminescent wire light source.

As best seen in FIG. 1 and FIG. 2, the electroluminescent wire light source 10 is mounted in a predetermined position on the exterior 28 of the baseball cap 12 to provide an illuminated display pattern. The electroluminescent wire is thin in circumference, linear and flexible for easy mounting on any surface of the cap. The electroluminescent wire emits light along its entire length. In these Figures, the electroluminescent wire 10 is securely attached along the edge 168 of the bill 16 of the baseball cap.

The electroluminescent wire is typically attached by sewing or gluing the translucent sheath of the electroluminescent wire light source to the edge of the bill. The electroluminescent wire can be attached by other fastening means such as tape, staples, Velcro, snaps, or support loops.

The attachment means should not interfere, or minimally interfere, with the emission of light from the electroluminescent wire light source though the front 170 of its translucent sheath. A rear portion 172 of the translucent sheath will be covered by the attachment means and, most especially, covered by the edge of the bill of the baseball cap.

A reflective surface 174 can be provided on the rear portion of the translucent sheath or on the edge of the bill adjacent to the electroluminescent wire. The reflective surface will typically be a metal foil or coating.

Light emitted by the electroluminescent wire will be transmitted through the back of the translucent sheath to the reflective surface. The reflective surface reflects the emitted light back through the electroluminescent wire so that the reflected light will not be absorbed by the edge of the bill but rather transmitted through the front of the translucent sheath. The reflected light will be additive to the front emitted light for increased illumination. The reflective surface also minimizes light being emitted towards the wearer's eyes.

When the electroluminescent wire light source is switched on, the electroluminescent wire light source forms an illuminated piping display for the baseball cap bill. As best shown in FIG. 2, a single unit 166 of the DC battery power source, the on/off switch 124, the DC/AC inverter and the control circuit is positioned in the interior of the baseball cap between the hat band and the crown on the inside of the baseball cap.

As shown in FIGS. 1 and 2, the sixth wire 158 and the seventh wire 162 extend from the end of the electroluminescent wire light source 10 on the edge 168 of the bill 16 on the outside 28 of the baseball cap 12 through a small hole 176 in the lower section of the crown 14 near the crown edge 24 into the space 178 between the hat band 34 and the crown 14 on the inside 30 of the baseball cap. The sixth wire and the seventh wire then extend along the space 178 between the hat band 34 and the crown 14 on the inside of the baseball cap to the single power supply and control circuit unit 164 also between the hat band and the crown on the inside of the baseball cap.

The sixth wire 158 and the seventh wire 162 are substantially concealed from view while electrically connecting the first and second electrodes of the electroluminescent wire light source to the control circuit in the power supply and control circuit unit. The sixth wire 158 and the seventh wire 162 can alternately be routed over the lower circumferential edge 24 of the crown 14 of the baseball cap between the electroluminescent wire light source 10 on the outside 28 of the cap and the power supply and control circuit unit 166 on the inside 30 of the cap (not shown in this Figure). The edge routing removes the need for the hole in the lower section of the crown.

The power supply and control circuit unit 166 of the electroluminescent wire illumination system is also concealed from view inside the baseball cap. The power supply and control circuit unit is thin enough and lightweight enough so that its presence inside the baseball cap will not be felt by the wearer. By positioning the unit between the hat band 34 and the crown 14, the hat band, and particularly a sweatband 40, will cushion the unit against the wearer's head. The switch 124 in the power supply and control circuit unit is accessible to the wearer to turn electroluminescent wire illumination system on and off. The DC power source, if the batteries are replaceable, should also be accessible to the wearer.

Alternately, the power supply and control circuit need not be a single unit. The DC battery power source, the on/off switch, the DC/AC inverter and the control circuit can be positioned separately along the space between the hat band and the crown to further reduce the thickness of the power supply and control circuit.

The power supply and control circuit unit can be secured in the space between the hat band and the crown by adhesive, sewing, Velcro, gluing or tape.

A particular advantage of using the electroluminescent wire light source is the ability of the electroluminescent wire light source to provide large amounts of bright light while consuming significantly less power and generating significantly less heat than incandescent light sources and fiber optic devices. The electroluminescent wire light source consume less power allowing the use of smaller, lightweight batteries, which need replacement less often than the power sources for incandescent light sources and fiber optic devices. The electroluminescent wire light source is less expensive than incandescent light sources and fiber optic devices.

As shown, in FIG. 4, the power supply and control circuit unit 166 can be positioned on the first and second panels 22a and 22b at the front of the inside crown 14. The unit can be placed above the forehead of the wearer to prevent the wearer's head from coming into contact with the power supply and control circuit unit. The front first and second panels have a reinforcing layer 32 to further support the weight of the power supply and control circuit unit. In FIG. 4, the electroluminescent wire light source 180 is mounted along the edge 168 of the bill 16 and the lower edge 24 of the crown 14 of the baseball cap.

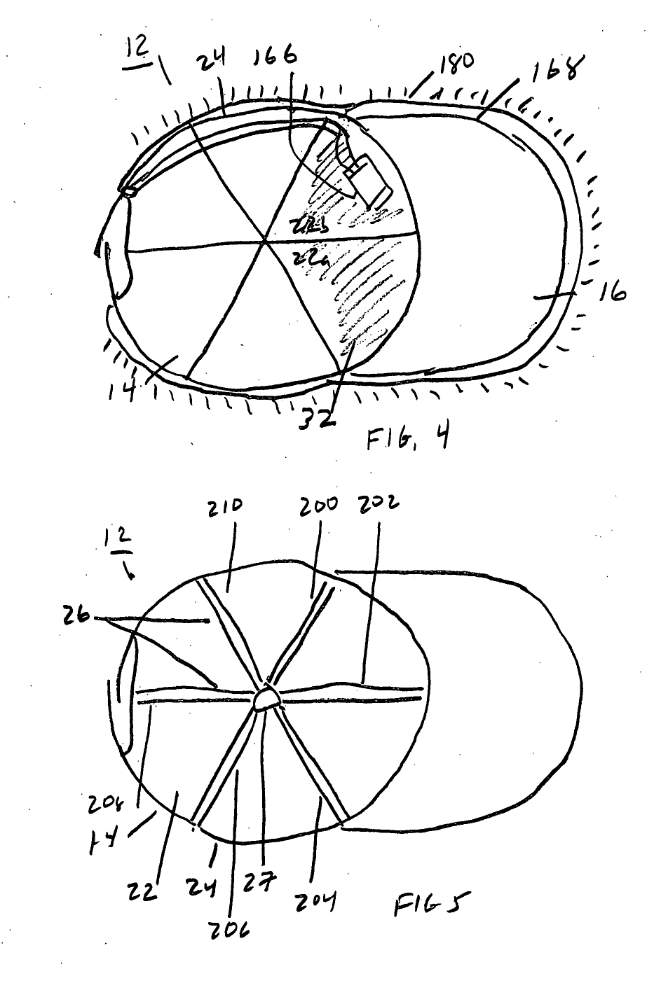

A plurality of electroluminescent wires 200, 202, 204, 206, 208, and 210 are mounted and positioned along the outside seams 26 from the lower edge 24 of the crown 14 to the button 27 at the top of the baseball cap 12 in FIG. 5. The seams are formed by the sewn together fabric panels 22 of the baseball cap. The multiple electroluminescent wire light sources can be electrically connected together so that the control circuit will control the electroluminescent wires in unison.

Alternately, each of the multiple electroluminescent wires can be individually controlled by the control circuit 212 as shown in FIG. 6. A fourth wire 146 still connects the third output terminal of the DC/AC inverter to the first input terminal 150 of the control circuit 212. A fifth wire 152 still connects the fourth output terminal of the DC/AC inverter to the second input terminal 156 of the control circuit 212.

A first wire 214 and a second wire 216 will connect the first output terminal 218 and the second output terminal 220 of the control circuit to the first electroluminescent wire 200.

A third wire 222 and a fourth wire 224 will connect the third output terminal 226 and the fourth output terminal 228 of the control circuit to the second electroluminescent wire 202.

A fifth wire 230 and a sixth wire 232 will connect the fifth output terminal 234 and the sixth output terminal 236 of the control circuit to the third electroluminescent wire 204.

A seventh wire 238 and an eighth wire 240 will connect the seventh output terminal 242 and the eighth output terminal 244 of the control circuit to the fourth electroluminescent wire 206.

A ninth wire 246 and a tenth wire 248 will connect the ninth output terminal 250 and the tenth output terminal 252 of the control circuit to the fifth electroluminescent wire 208.

An eleventh wire 254 and a twelfth wire 256 will connect the eleventh output terminal 258 and the twelfth output terminal 260 of the control circuit to the sixth electroluminescent wire 210.

The multiple outputs allows individual control of the electroluminescent wire light sources by the control circuit.

The control circuit may contain predetermined illumination sequences for specific time periods for specific display patterns. The control circuit may also utilize random illumination patterns.

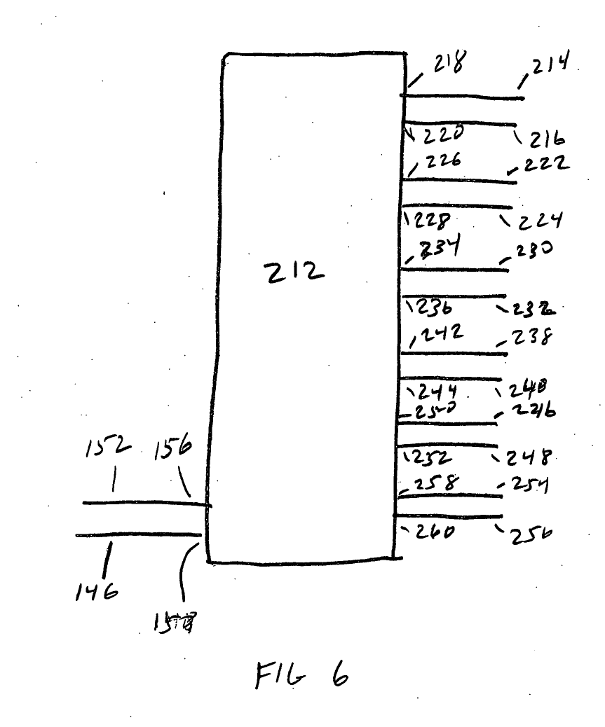

An electroluminescent wire light source 300 can encircle the button 27 at the top of the baseball cap 12, as shown in FIG. 7.

An electroluminescent wire light source 302 can form an illuminated display pattern, a star in this illustrative example, on the front reinforced first and second panels 22a and 22b of the baseball cap 12 as shown in FIG. 8.

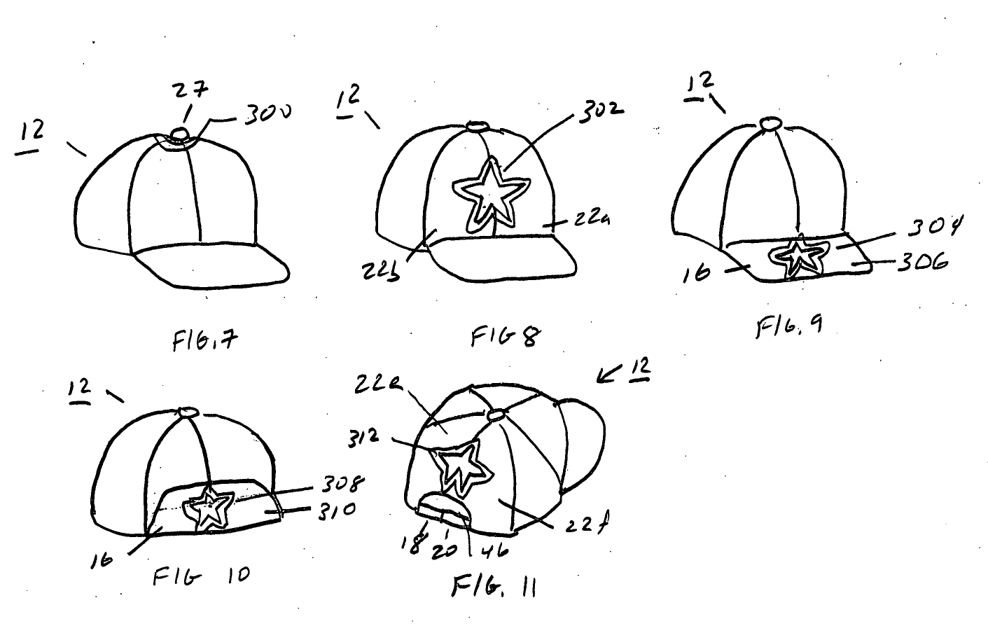

An electroluminescent wire light source 304 can form an illuminated pattern, a star in this illustrative example, on the upper surface 306 of the bill 16 of the baseball cap 12 in FIG. 9.

An electroluminescent wire light source 308 can form an illuminated pattern, a star in this illustrative example, on the lower surface 310 of the bill 16 in FIG. 10, when the bill of the baseball cap 12 is worn in a flipped up fashion.

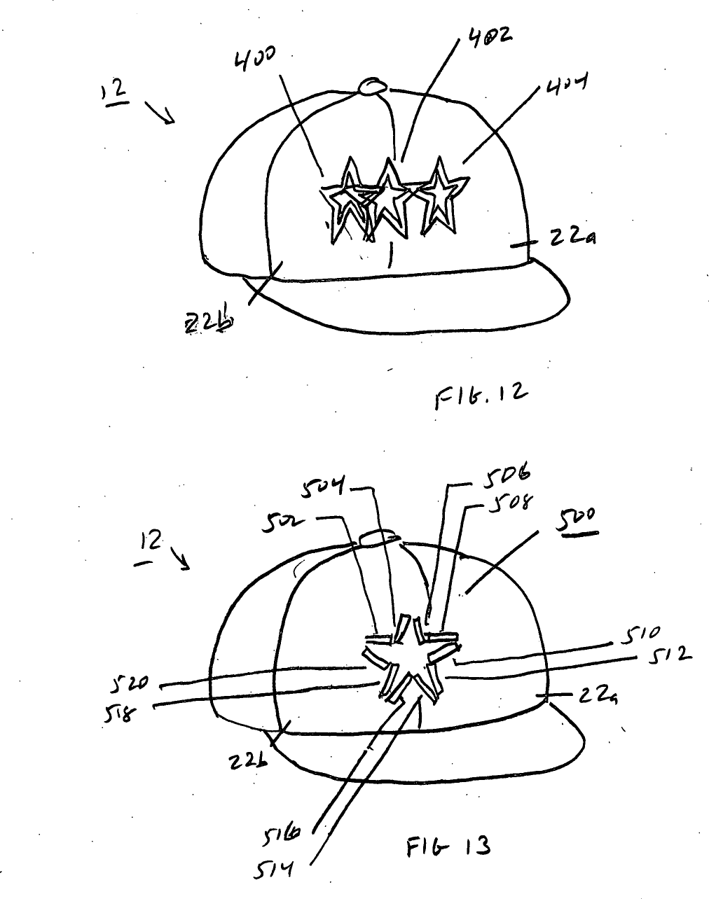

An electroluminescent wire light source 312 can form an illuminated pattern, a star in this illustrative example, on the back of the baseball cap 12, typically above the adjustable straps 28 and 20 semi-circular opening 46 in fifth and sixth back panels 22e and 22f in FIG. 11.

This back positioning of the electroluminescent wire is especially useful when the baseball cap is worn in a backwards fashion so that the back of the cap faces forward.

FIG. 1 to 11 show various illustrative examples of positioning electroluminescent wire light sources on the outside of the baseball cap on the crown and bill.

The examples in these Figures are not exhaustive, but merely illustrative. Similarly, the star pattern is merely an illustrative example, other illuminated patterns including words, names, letters, numbers, graphics, designs, shapes, logos, insignia and images are possible.

A plurality of electroluminescent wire light sources 400, 402 and 404 can form a time sequenced illuminated pattern to simulate motion on the front reinforced first and second panels 22a and 22b of the baseball cap 12 as shown in FIG. 12.

A first electroluminescent wire light source 400 in the illuminated pattern of a star, a second electroluminescent wire light source 402 in the illuminated pattern of a star, and a third electroluminescent wire light source 404 in the illuminated pattern of a star are spaced offset in position from each other on the front panels 22a and 22b of the baseball cap. The electroluminescent wire light sources are sequentially activated by the control circuit.

Each of the electroluminescent wire light sources is supplied with power to emit light by the control circuit for a predetermined period of time. After that predetermined period of time, the adjacent electroluminescent wire light source is supplied with power to emit light by the control circuit for a predetermined period of time until each of the electroluminescent wire light sources has been activated in turn.

The timing of the electroluminescent wire light sources may be dependent upon the nature of the images. Each of the electroluminescent wire light sources can be turned off and the emitted light extinguished by the control circuit at approximately the same time as the adjacent electroluminescent wire light source is turned on and starts emitting light. However, for certain displays, it may be desirable to overlap the light emission of adjacent electroluminescent wire light sources.

This time sequenced illumination display from a plurality of electroluminescent wires provides sequential image motion or animation to an illuminated display.

The electroluminescent wire light sources can be different illuminated patterns in a changing illuminated display.

The plurality of electroluminescent wire light sources can form separate, non-overlapping patterns which are illuminated in a time sequenced pattern. The individual patterns can be the same or different for the plurality of electroluminescent wire light sources in the illuminated display. As noted previously, the electroluminescent wire light sources along the seams of the baseball cap in FIG. 6 can be illuminated in unison or in various patterns.

A single illuminated display 500 can be formed of a plurality of segments with each segment being an electroluminescent wire light sources on the front panels 22a and 22b of the baseball cap 12. The single star pattern 500 of FIG. 13 is formed of ten straight-line electroluminescent wire light sources 502, 504, 506, 508, 510, 512, 514, 516, 518, and 520. The control circuit can illuminate each electroluminescent wire light segment in a time sequenced pattern. The illuminated display can have a chase sequence of one electroluminescent wire light segment being illuminated then extinguished, followed by the adjacent electroluminescent wire light segment being illuminated then extinguished, so that the light seems to chase around the star pattern.

The positions of the electroluminescent wire light source on the baseball cap are merely illustrative examples. Other positions are possible. The electroluminescent wire light source can be on multiple positions on the same baseball cap, such as the edge of the bill and the seams on the crown. The electroluminescent wire light sources on multiple positions on the baseball cap can illuminate in unison or illuminate separately or illuminate in a pattern.

An electroluminescent wire is mounted in a predetermined position on the exterior of the baseball cap to provide an illuminated display. The electroluminescent wire comprises a thin linear light source wherein light is produced by activating an electroluminescent phosphor with alternating electric current. The power supply and control circuit for the electroluminescent wire are positioned on the interior of the baseball cap. The result is a highly attractive illuminated design which is durable, inexpensive and flexible in that it can be readily mounted anywhere on the baseball cap to provide various illuminated designs. The light source does not generate much heat, uses little power and is weather-resistant. The electroluminescent wire light source is flexible, shapeable and radiates light uniformly in all directions. A reflective backing can direct all the emitted light forward. The light source may be monochrome or polychrome, depending upon the type of electroluminophor powder(s) used and the color of the protective sheath.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

What is claimed is:

1. An illumination system for a cap comprising:
a cap having an exterior surface and an interior surface;
an electroluminescent wire light source mounted on said exterior surface of said cap, said electroluminescent wire light source forming a display pattern; and
a power supply and control circuit positioned on said interior surface of said cap, said power supply and control circuit supplying power to said electroluminescent wire light source, wherein said electroluminescent wire light source emits light in said display pattern.

2. The illumination system for a cap of claim 1 wherein said power supply is a DC power supply, said control circuit has an inverter for converting said DC power from said DC power supply to an AC current, said control circuit supplies said AC current to said electroluminescent wire light source.

3. The illumination system for a cap of claim 2 wherein said DC power supply is at least one battery.

4. The illumination system for a cap of claim 1 wherein said control circuit has a manually operable switch to control the supplying of power to said electroluminescent wire light source turning the emission of light from said electroluminescent wire light source on and off.

5. The illumination system for a cap of claim 1 wherein said control circuit has a motion sensitive switch to control the supplying of power to said electroluminescent wire light source turning the emission of light from said electroluminescent wire light source on and off.

6. The illumination system for a cap of claim 1 wherein said control circuit causes said electroluminescent wire light source to emit light in a regular interval flashing pattern.

7. The illumination system for a cap of claim 1 wherein said control circuit causes said electroluminescent wire light source to emit light in a random interval flashing pattern.

8. The illumination system for a cap of claim 1 wherein said control circuit controls the brightness of the light emitted by said electroluminescent wire light source.

9. The illumination system for a cap of claim 1 wherein said illumination system has a plurality of electroluminescent wire light sources on said exterior surface of said cap, wherein said control circuit controls each of said plurality of electroluminescent wire light sources, individually or in unison.

10. The illumination system for a cap of claim 9 wherein each of said plurality of electroluminescent light sources forms a segment of a single display pattern, said single display pattern being formed of a plurality of segments.

11. The illumination system for a cap of claim 9 wherein each of said plurality of electroluminescent light sources has a corresponding display pattern, said control circuit controls each of said plurality of electroluminescent wire light sources such that each of said display patterns is illuminated in a time sequenced pattern.

12. The illumination system for a cap of claim 1 wherein said electroluminescent wire light source has a first conductive electrode, a second conductive electrode, an electroluminescent material between said first conductive electrode and said second conductive electrode, and a translucent sheath around said electroluminescent material, said first conductive electrode and said second conductive electrode, wherein power supplied to said first conductive electrode and said second conductive electrode causes said electroluminescent material to emit light through said translucent sheath.

13. The illumination system for a cap of claim 12 wherein said electroluminescent material emits light of at least two different colors for said display pattern.

14. The illumination system for a cap of claim 12 wherein said translucent sheath colors said emitted light into at least two different colors for said display pattern.

15. The illumination system for a cap of claim 1 wherein said cap has a crown and a bill extending from the front of said crown, wherein said electroluminescent wire light source is mounted on the edge of said bill.

16. The illumination system for a cap of claim 1 wherein said cap has a crown, said crown being formed of adjacent panels attached together, wherein said electroluminescent wire light source is mounted on the seams between said adjacent panels.

17. The illumination system for a cap of claim 1 wherein said cap has a crown and a bill extending from the front of said crown, said crown being formed of adjacent panels attached together, said crown having at least one front panel above said bill, said electroluminescent wire light source is mounted on said at least one front panel.

18. An illumination system for a cap comprising:
a cap having an exterior surface and an interior surface, said cap having a crown and a bill extending from the front of said crown, said crown being formed of adjacent panels attached together, said crown having at least one front panel above said bill,
an electroluminescent wire light source mounted on said exterior surface of said cap on said at least one front panel, said electroluminescent wire light source having a first conductive electrode, a second conductive electrode, an electroluminescent material between said first conductive electrode and said second conductive electrode, and a translucent sheath around said electroluminescent material, said first conductive electrode and said second conductive electrode, said electroluminescent wire light source forming a display pattern; and
a power supply and control circuit positioned on said interior surface of said cap, said power supply being at least one battery providing a DC power supply, said control circuit having an inverter for converting said DC power from said DC power supply to an AC current, said control circuit supplying said AC current to said first conductive electrode and said second conductive electrode of said electroluminescent wire light source causing said electroluminescent material of said electroluminescent wire light to emit light through said translucent sheath of said electroluminescent wire light in said display pattern, wherein said control circuit has a manually operable switch to control the supplying of AC current to said electroluminescent wire light source turning the emission of light from said electroluminescent wire light source on and off.
